(19) United States
(12) Patent Application Publication
(10) Pub. No.: US 2026/0127074 A1
(43) Pub. Date: May 7, 2026

(54) MEMORY DEVICE STACK AVAILABILITY

(71) Applicant: Rambus Inc., San Jose, CA (US)

(72) Inventors: Dongyun LEE, Sunnyvale, CA (US); Wendy ELSASSER, Austin, TX (US); John Eric LINSTADT, Palo Alto, CA (US)

(21) Appl. No.: 19/119,972

(22) PCT Filed: Oct. 16, 2023
(86) PCT No.: PCT/US2023/035216

§ 371 Date: Apr. 10, 2025

Related U.S. Application Data
(60) Provisional application No. 63/417,534, filed on Oct. 19, 2022.
(60) Provisional application No. 63/447,821, filed on Feb. 23, 2023.

(51) Int. Cl. G06F 11/10

(52) U.S. Cl. CPC G06F 11/1096

(57) ABSTRACT

As information is written to a memory device stack, partial parity information is calculated by the non-parity devices in the stack from the information being written to that device and parity information received from the next lower device in the stack (if any). The partial parity information calculated by each non-parity device is transmitted to the next higher device in the stack so that it may perform a partial parity calculation using the partial parity information collectively calculated by the devices lower in the stack. Once complete parity has been collectively calculated by all of the non-parity devices in the stack, the complete parity information is stored by the parity memory device. The complete parity information may be used to recover or reconstruct data from a failing device in the stack by calculating and transmitting parity information from non-failing devices to the failing device and/or the parity device.

### BRIEF DESCRIPTION OF THE DRAWINGS

FIGS. 1A-1H are notional diagrams illustrating a memory device stack.

FIGS. 2A-2C are example timing diagrams illustrating memory device stack operations.

FIG. 3 is a flowchart illustrating a method of operating a memory device stack.

FIG. 4 is a flowchart illustrating a method of operating a memory device stack having a failed device.

FIG. 5 is a flowchart illustrating a method of recovering information stored in a memory device stack having a failed device.

FIG. 6 is a block diagram of a processing system.

### DETAILED DESCRIPTION OF THE EMBODIMENTS

In an embodiment, a stack of memory devices includes a parity memory device to store parity information. As information is written to the memory device stack, partial parity information is calculated by the non-parity devices in the stack from the information being written to that device and parity information received from the next lower device in the stack (if any). The partial parity information calculated by each non-parity device is transmitted to the next higher device in the stack so that it may perform a partial parity calculation using the partial parity information collectively calculated by the devices lower in the stack. Once complete parity has been collectively calculated by all of the non-parity devices in the stack, the complete parity information is stored by the parity memory device.

In an embodiment, in the event of a failure of a non-parity device, the memory device stack is configured to recreate the information being read from the failed device using the parity from the parity device and the information being read from the non-failing non-parity devices. In particular, the complete parity information is read from the parity device and transmitted to the next lower device in the stack. Each non-parity device then calculates partial recovery parity information using information read from its array and the information received from an adjacent device. The partial recovery parity calculated by each non-failing device is transmitted in the direction (up or down) leading to the failing device. The failing device receives partial recovery parity information adjacent device(s) and is able to recreate the information originally stored by it using this information.

In an embodiment, in the event of a failure of a non-parity device, the memory device is configured to recreate the information stored by the failing non-parity device in the parity memory device. In particular, each non-failing non-parity device calculates partial parity information from the information read from that device and parity information received from the next lower device in the stack (if any). The partial parity information calculated by each non-parity device is transmitted to the next higher device in the stack so that it may perform a partial parity calculation using the partial parity information collectively calculated by the devices lower in the stack. Once a recovery parity has been collectively calculated by all of the non-failing non-parity devices in the stack, the recovery parity information is transmitted to the parity memory device. The parity memory device calculates the information originally stored by the failing device from the recovery parity information, and the complete parity information read from the array of the parity memory device. The recovered information originally stored by the failing device is then written back to the array of the parity memory device. This process may be repeated for every location of the memory device stack in order to allow the parity memory device to replace the functionality of the failed non-parity device.

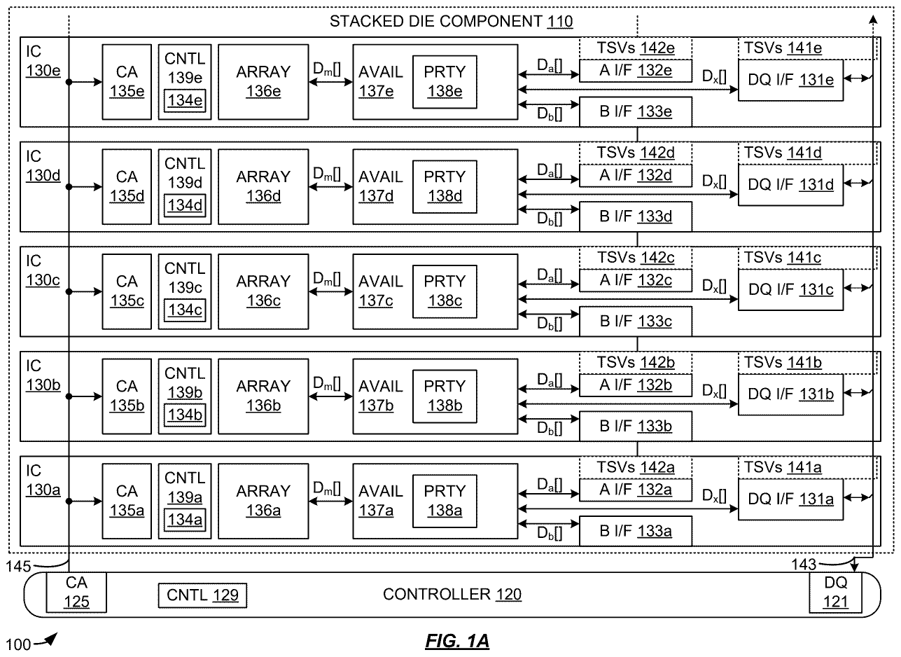

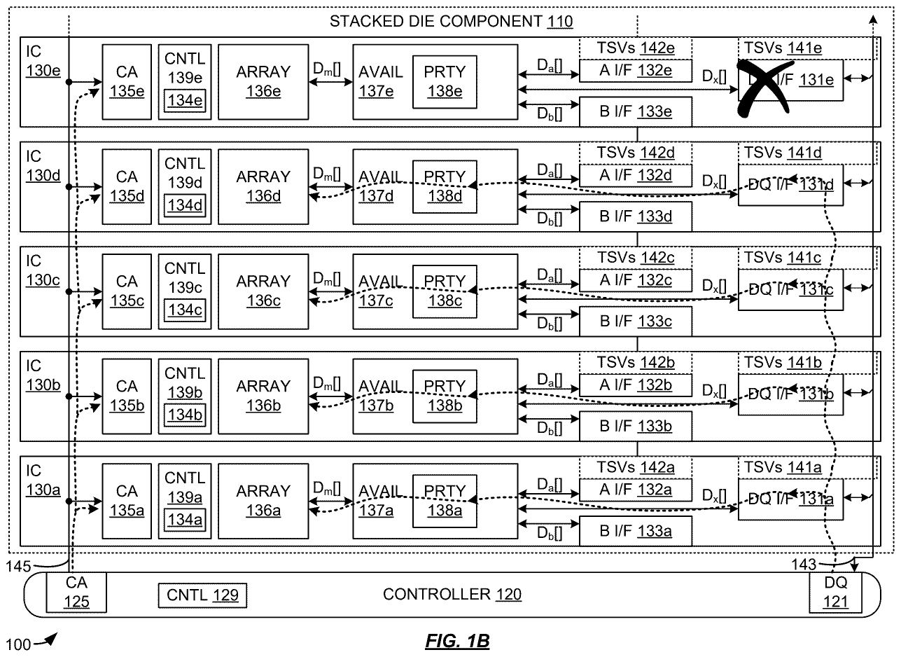

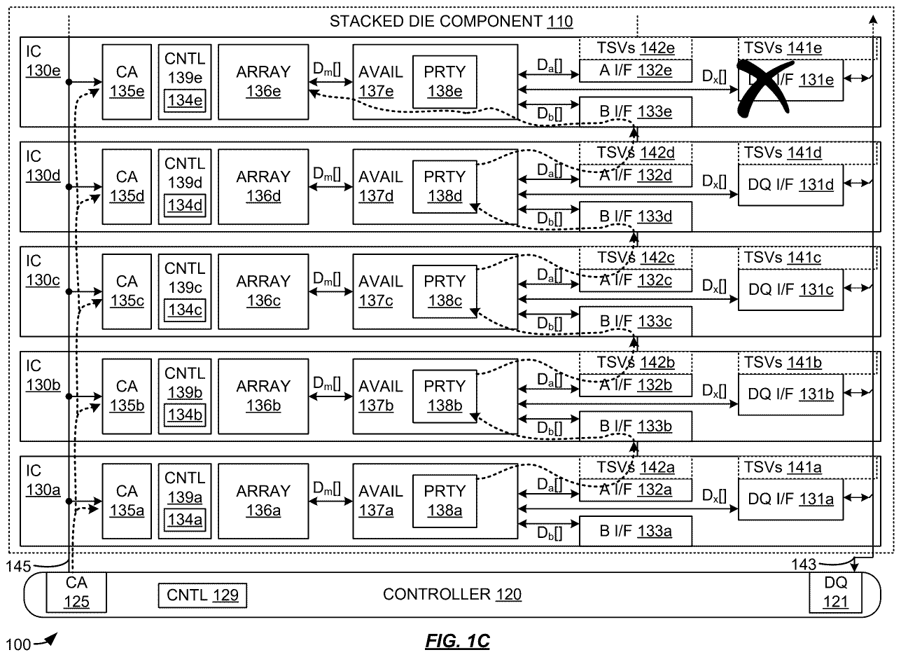

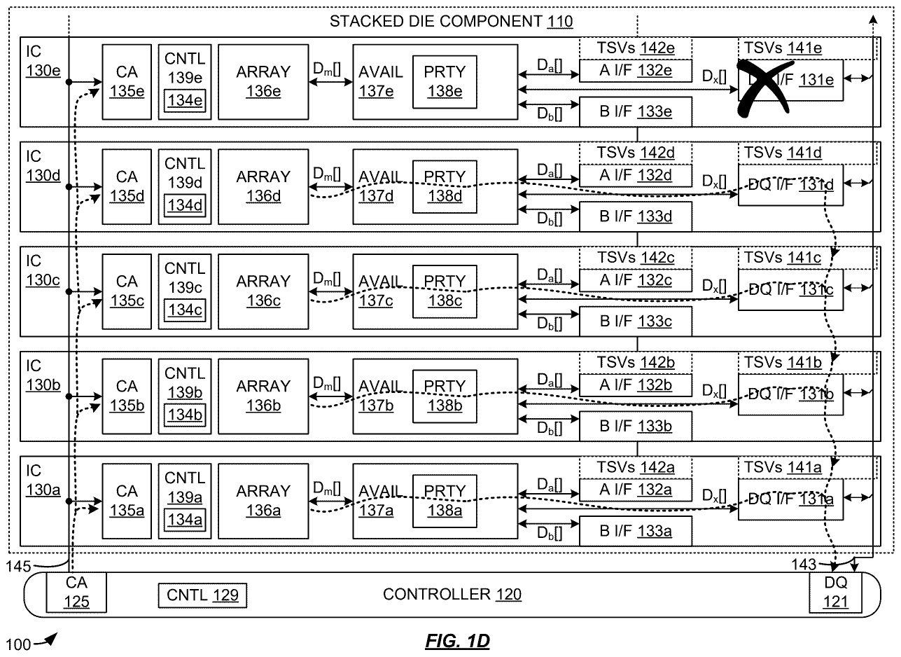

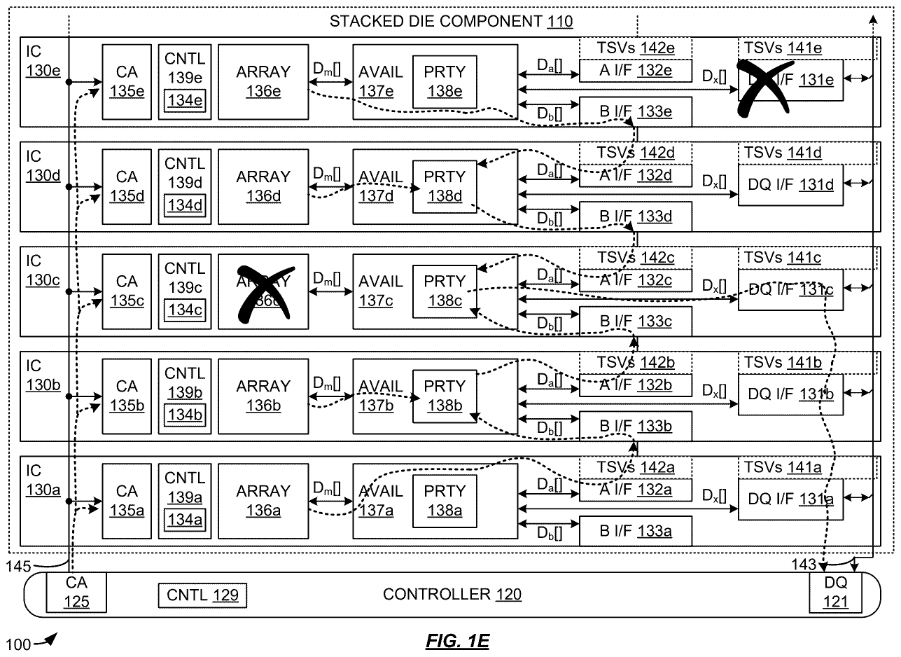

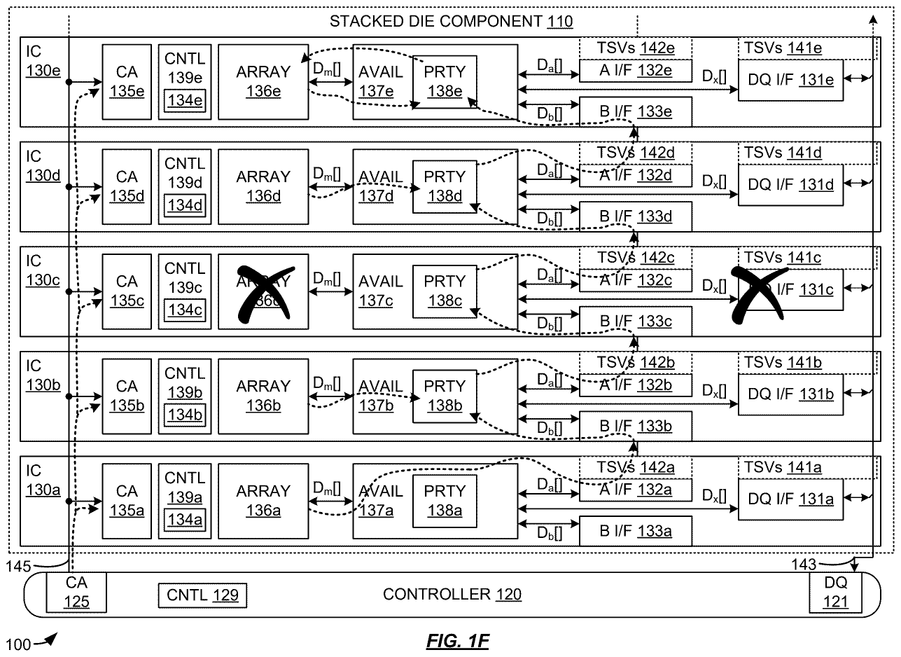

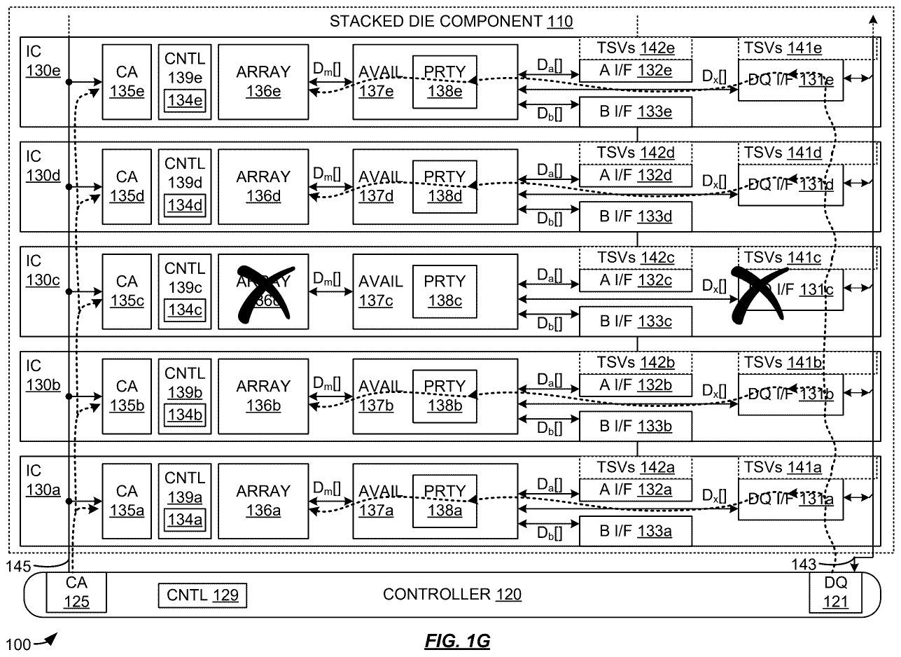

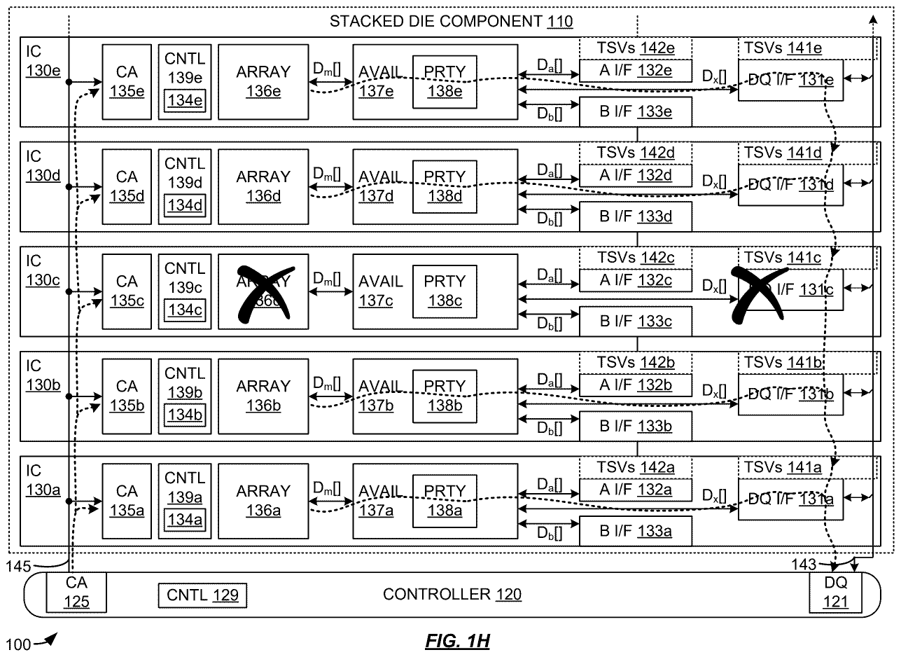

FIGS. 1A-1H are notional diagrams illustrating a memory device stack. In FIGS. 1A-1H, memory system 100 comprises stacked die component 110 and controller 120. Stacked die component 110 includes memory integrated circuit (IC) dies 130a-130e, command/address (CA) interface 145, and data (DQ) interface 143. Each of memory integrated circuit die 130a-130e each respectively include DQ interface 131a-131e, parity “A” (“above”) interface 132a-132e, parity “B” (“below”) interface 133a-133e, command/address (CA) interface 135a-135e, at least one memory array 136a-136e, availability circuitry 137a-137e, control circuitry 139a-139e, data through-silicon vias (TSVs) 141a-141e, and parity TSVs 142a-142e. Availability circuitry 137a-137e each respectively include parity circuitry 138a-138e. Control circuitry 139a-139e each respectively include mode circuitry 134a-134e.

Controller 120 and memory integrated circuit die 130a-130e are integrated circuit type devices, such as those commonly referred to as “chips”. A memory controller, such as controller 120, manages the flow of data going to and from memory devices. Functionality of a memory controller may be included on a single die with a microprocessor, or included as part of a more complex integrated circuit system as a block of a system on a chip (SOC). For example, a memory controller may be a northbridge chip, an application specific integrated circuit (ASIC) device, a load-reduction memory buffer, a graphics processor unit (GPU), a system-on-chip (SoC), a chiplet co-packaged with CPU and/or GPU cores, or an integrated circuit device that includes many circuit blocks such as ones selected from graphics cores, processor cores, and MPEG encoder/decoders, etc.

Controller 120, stacked die component 110, and memory integrated circuit die 130a-130e may be interconnected with each other in a variety of system topologies including on a PC board (e.g., where stacked die component 110 is on a module and controller 120 is socketed to the PC board, or in “die-down” arrangement where one or more of the components are soldered to the PC board). Stacked die component 110 comprises a stack of memory integrated circuit die 130a-130e co-packaged together and coupled to each other and/or controller 120 via wired bonds and/or TSVs. In an embodiment, all memory IC dies 130a-130e in stacked die component 110 may be identical. In various embodiments, controller 120 may or may not be included in stacked die component 110 with memory IC dies 130a-130e. Controller 120 includes data (DQ) interface 121, command/address (CA) interface 125, and control circuitry 129.

The descriptions and embodiments disclosed herein may be made with references to DRAM memory IC dies. This, however, should be understood to be a first example. Other example memory technologies include, but are not limited to static random access memory (SRAM), non-volatile memory (such as flash), conductive bridging random access memory (CBRAM—a.k.a., programmable metallization cell—PMC), resistive random access memory (a.k.a., RRAM or ReRAM), magnetoresistive random-access memory (MRAM), Spin-Torque Transfer (STT-MRAM), phase change memory (PCM), and the like, and/or combinations thereof. Accordingly, it should be understood that in the disclosures and/or descriptions given herein, these aforementioned technologies may be substituted for, included with, and/or encompassed within, references to memory IC die, memory devices, memory, DRAM, DRAM devices, memory arrays, and/or DRAM arrays made herein.

CA interface 125 of controller 120 is operatively coupled (e.g., connected) to the CA interface 135a of memory IC die 130a, CA interface 135b of memory IC die 130b, CA interface 135c of memory IC die 130c, CA interface 135d of memory IC die 130d, and CA interface 135e of memory IC die 130e via CA interface 145 of stacked die component 110. In an embodiment, CA interfaces 135a-135e each received the same commands/addresses from CA interface 125. Thus, memory IC dies 130a-130e may each perform the same operations/accesses to the same addresses in response to the same commands, as transmitted by controller 120 and received by the memory IC dies 130a-130e in stacked die component 110.

A interface 132a of memory IC die 130a is operatively coupled to the B interface 133b of memory IC die 130b via parity TSVs 142a. A interface 132b of memory IC die 130b is operatively coupled to B interface 133c of memory IC die 130c via parity TSVs 142b. A interface 132c of memory IC die 130c is operatively coupled to B interface 133d of memory IC die 130d via parity TSVs 142c. A interface 132d of memory IC die 130d is operatively coupled to B interface 133e of memory IC die 130e via parity TSVs 142d. A interface 132e of memory IC die 130e may, in some embodiments, be operatively coupled to another B interface of another device in stacked die component 110, if present (not shown in FIGS. 1A-1H).

DQ interface 121 of controller 120 is operatively coupled to DQ interface 131a of memory IC die 130a, DQ interface 131b of memory IC die 130b, DQ interface 131c of memory IC die 130c, DQ interface 131d of memory IC die 130d, and DQ interface 131e of memory IC die 130e via DQ interface 143 of stacked die component 110. In an embodiment, the DQ interfaces 131a-131e are each 2 bits wide. In an embodiment, DQ interface 143 may be 8 bits wide and DQ interface 131e of memory IC die 130e is disabled and/or not coupled to DQ interface 143. In an embodiment, DQ interface 143 may be 10 bits wide. In these embodiments, each DQ interface 131a-131e (if connected) is configured to be operatively coupled to different data signals of DQ interface 121 using one or more of the TSVs 141a-141e of memory IC dies 130a-130e.

In other words, the DQ signals of DQ interface 131a (e.g., DQ[0:1]) may be configured to communicate with corresponding DQ signals of DQ interface 121 (e.g., DQ[0:1]) via TSVs 141a; the DQ signals of DQ interface 131b (e.g., DQ[0:1]) may configured to communicate with different but corresponding DQ signals of DQ interface 121 (e.g., DQ[2:3]) via TSVs 141b and TSVs 141a; the DQ signals of DQ interface 131c (e.g., DQ[0:1]) may configured to communicate with different but corresponding DQ signals of DQ interface 121 (e.g., DQ[4:5]) via TSVs 141c, TSVs 141b, and TSVs 141a; and so on. Thus, in the aforementioned eight bit embodiment, DQ interface 121 may be configured to communicate two bits with each of memory IC dies 130a-130d. In the aforementioned ten bit embodiment, DQ interface 121 may configured to communicate two bits with each of memory IC dies 130a-130e and the DQ signals of memory IC die 130e may be used by controller 120 when stacked die component 110 is configured to have memory IC die 130e replace the functionality of a one of memory IC dies 130a-130d.

Respective availability circuitry 137a-137e of each of memory integrated circuit die 130a-130e is operatively coupled with its respective memory array 136a-136e via a respective internal memory array bus Dₘ[ ]. Respective availability circuitry 137a-137e of each of memory integrated circuit die 130a-130e is operatively coupled with its respective DQ interface 131a-131e via a respective internal data bus Dₓ[ ]. Respective availability circuitry 137a-137e of each of memory integrated circuit die 130a-130e is operatively coupled with its A interface 132a-132e via a respective internal A interface bus Dₐ[ ]. Respective availability circuitry 137a-137e of each of memory integrated circuit die 130a-130e is operatively coupled with its B interface 133a-133e via a respective internal B interface bus D_{b}[ ].

FIG. 1B illustrates a first example operation performed for a write to stacked die component 110. In FIG. 1B, controller 120 transmits a write command and address to stacked die component 110 via CA interface 125 and CA interface 145. The write command and address are provided by stacked die component 110 to the CA interfaces 135a-135e of memory IC dies 130a-130e (e.g., by TSVs, not shown in FIGS. 1A-1H). This is illustrated in FIG. 1B by the arrow originating with CA interface 125 of controller 120 and branches off that arrow running to CA interfaces 135a-135e.

As part of the write operation, controller 120 transmits write data to stacked die component 110 via DQ interface 121 and DQ interface 143. Corresponding portions (e.g., two bits) of the write is provided by stacked die component 110 to respective DQ interfaces 131a-131d of memory IC dies 130a-130d (e.g., by one or more of TSVs 141a-141d). This is illustrated in FIG. 1B by the arrow originating with DQ interface 121 of controller 120 and branches off that arrow running to DQ interfaces 131a-131d via one or more of TSVs 141a-141c. DQ interfaces 131a-131d provide their respectively received write data to their availability circuitry 137a-137d (and respective parity circuitry 138a-138d, in particular) and their memory array 136a-136d. Respectively received write data is stored (i.e., written) to the respective memory array 136a-136d (e.g., under the control of control circuitry 139a-139d). Note that in this example, parity memory IC die 130e does not write data received from controller 120 to memory array 136e (e.g., either because it was configured not to, DQ interface 131e was disabled, and/or TSVs 141e were not connected to TSVs 141d).

FIG. 1C illustrates a second example operation performed for a write to stacked die component 110. In FIG. 1C, after or concurrently with the write data being provided to availability circuitry 137a-137d by a respective DQ interface 131a-131d, memory IC die 130a (e.g., by availability circuitry 137a, in particular) provides the write data it received to memory IC die 130b via A interface 132a, TSVs 142a, and B interface 133b of memory IC die 130b. This is illustrated in FIG. 1C by the arrow running from availability circuitry 137a to parity circuitry 138b of memory IC die 130b via A interface 132a, TSVs 142a, and B interface 133b.

Memory IC die 130b calculates a first partial parity from the data it received from memory IC die 130a and the write data it received via DQ interface 131b. Memory IC die 130b provides the first partial parity to memory IC die 130c via A interface 132b, TSVs 142b, and B interface 133c of memory IC die 130c. This is illustrated in FIG. 1C by the arrow running from availability circuitry 137b (and parity circuitry 138b, in particular) to parity circuitry 138c of memory IC die 130c via A interface 132b, TSVs 142b, and B interface 133c.

Memory IC die 130c calculates a second partial parity from the first partial parity data it received from memory IC die 130b and the write data it received via DQ interface 131c. Memory IC die 130c provides the second partial parity to memory IC die 130d via A interface 132c, TSVs 142c, and B interface 133d of memory IC die 130d. This is illustrated in FIG. 1C by the arrow running from availability circuitry 137c (and parity circuitry 138c, in particular) to parity circuitry 138d of memory IC die 130d via A interface 132c, TSVs 142c, and B interface 133d.

Memory IC die 130d calculates a complete parity from the second partial parity data it received from memory IC die 130c and the write data it received via DQ interface 131d. Memory IC die 130d provides the complete parity to memory IC die 130e via A interface 132d, TSVs 142d, and B interface 133e of memory IC die 130e. This is illustrated in FIG. 1C by the arrow running from availability circuitry 137d (and parity circuitry 138d, in particular) to parity circuitry 138e of memory IC die 130e via A interface 132d, TSVs 142d, and B interface 133e.

Memory IC die 130e stores the complete parity it received from memory IC die 130d in memory array 136e as part of the write operation being performed by stacked die component 110 in response to the write command. This is illustrated in FIG. 1C by the arrow running from availability circuitry 137d (and parity circuitry 138d, in particular) to memory array 136e of memory IC die 130e via A interface 132d, TSVs 142d, B interface 133e, and availability circuitry 137e.

From the foregoing, it should be understood that for the respective data output by each memory IC die 130a-130d on A interface 132a-132d may be expressed as Dₐ[ ]=Dₓ[ ] ⊗D_{b}[ ] where D_{b}[ ] for memory IC die 130a (e.g., the “bottom” device) is equivalent to all logical “0”'s. In other words, for example, where Dₐ[ ], D_{b}[ ], Dₓ[ ], and Dₘ[ ] are each 32 bits wide, each memory IC die 130a-130d calculates, receives, and propagates parity/partial parity according to the formula: Dₐ[0:31]=Dₓ[0:31] @D_{b}[0:31] where D_{b}[0:31] for memory IC die 130a is set or configured to be 32′h0000_0000 (or equivalent). Thus, it should also be understood that parity memory IC die 130e stores a complete parity value, as collectively calculated by memory devices 130a-130d according to:

$${D}_{m , 130 e} [ 0 : 31 ] = {D}_{x , 130 a} [ 0 : 31 ] ⊗ {D}_{x , 130 b} [ 0 : 31 ] ⊗ {D}_{x , 130 c} [ 0 : 31 ] ⊗ {D}_{x , 130 d} [ 0 : 31 ] = {D}_{b , 130 e} [ 0 : 31 ]$$

(or equivalent) based on the write command transmitted to stacked die component 110.

FIG. 1D illustrates a first example operation performed for a read from stacked die component 110. In FIG. 1D, controller 120 transmits a read command and address to stacked die component 110 via CA interface 125 and CA interface 145. The read command and address are provided by stacked die component 110 to the CA interfaces 135a-135e of memory IC dies 130a-130e (e.g., by TSVs, not shown in FIGS. 1A-1H). This is illustrated in FIG. 1D by the arrow originating with CA interface 125 of controller 120 and branches off that arrow running to CA interfaces 135a-135e.

As part of the read operation, each data memory IC die 130a-130d transmits read data to controller 120 via one or more TSVs 141a-141d, DQ interface 143, and DQ interface 121. Corresponding portions (e.g., two bits) of the read data are provided by each data memory IC die 130a-130d by respective DQ interfaces 131a-131d to controller 120. This is illustrated in FIG. 1D by the arrows originating with arrays 136a-136d that join with the other arrows and run to DQ interface 121 via one or more of TSVs 141a-141c.

It should be understood from the foregoing that for the respective data provided by each memory IC die 130a-130d to its DQ interface 131a-131d for provision to controller 120 may be expressed as Dₓ[ ]=Dₘ[ ] and that data may not be output or received via A interface 132a-132d, nor may not be output or received via B interface 133a-133d. In other words, for example, where Dₐ[ ], Do [ ], Dₓ[ ], and Dₘ[ ] are each 32 bits wide, each memory IC die 130a-130d Dₓ[0:31]=Dₘ[0:31]. Dₐ[0:31] and/or D_{b}[0:31] may be set to a predefined value (e.g., 32′h0000_0000), undefined, and/or used for other purposes (e.g., checking parity) during read operations.

Also note that in the foregoing example, parity memory IC die 130e does not provide data (i.e., complete parity) from array 136e via DQ interface 131e (e.g., either because it was configured not to, DQ interface 131e was disabled, and/or TSVs 141e were not connected to TSVs 141d). However, in some embodiments, modes, and/or configurations, parity memory IC die 130e may provide parity data from array 136e via DQ interface 131e to controller 120 via DQ interface 143, TSVs 141a-141e, and DQ interface 121 so that controller may check for an error in the data and parity read from stacked die component 110 (not shown in FIG. 1D). In addition, in some embodiments, modes, and/or configurations, parity memory IC die 130e may provide parity data from array 136e to parity circuitry 138e, dies 130a-130d collectively calculate complete parity and deliver to die 130e (e.g., via B interface 133e). Availability circuitry 137e then checks (e.g., by comparing all or sub-parts—e.g., two halves of) the retrieved complete parity (e.g., D_{M}[ ]) and the received complete parity (e.g., D_{b}[ ]) and delivers the result(s) of the check(s) to one or more of DQ[8:9] via DQ interface 131e.

In an embodiment stacked die component 110 may be placed in a recovery mode to provide recovered data previously stored by a failing/failed memory IC die 130a-130d. Based on being in a recovery mode (e.g., modes set by mode circuitry 134a-134e), the memory IC dies 130a-130e of stacked die component 110 collectively act to recover the data in the failing/failed device. The non-failing/failed memory IC dies (e.g., memory IC dies 130a-130b and 130d-130e in FIG. 1E) in stacked die component 110 collectively provide parity data to the failing/failed device (e.g., memory IC die 130c in FIG. 1E) so that failing/failed device can respond to read commands with data reconstructed/calculated from the parity data from the non-failing/failed devices. The non-failing/failed memory IC dies 130a-130e in stacked die component 110 collectively provide parity data to the failing/failed device using A interfaces 132a-132d, TSVs 142a-142d, and B interfaces 133b-133e. Each non-failing memory IC die 130a-130e reads data corresponding to the read command from its memory array 136a-136e. Parity memory IC die 130e provides the stored complete parity information to its B interface 133e where the complete parity information is received by memory IC die 130d via TSVs 142d and A interface 132d.

Except for the parity memory IC die 130e, the data read from the non-failing/failed memory IC die memory array 136a-136d is provided by the non-failing/failed memory IC die 130a-130d to its respective DQ interface 131a-131d (not shown in FIG. 1E). Each non-failing/failed die 130a-130d also combines the data from its memory array 136a-136d with parity information received via a one of its A interface 132a-132d (if any) or B interface 133b-133d (if any) to generate partial parity information that is transmitted in the direction of the failing/failed die 133a-133d (i.e., via the one of its A interface 132a-132d or B interface 133b-133d that will propagate the partial parity information it calculated towards the failing/failed memory IC die 130a-130d). The failed die uses the parity information received via one or both of its A interface 132a-132d and B interface 133b-133d to recover the data stored in its (failing or failed) memory array 136a-136d and provide that recovered data to its respective DQ interface 131a-131d in response to the read command.

These operations and dataflows are illustrated by example in FIG. 1E. In FIG. 1E, memory IC die 130c is configured as the failing/failed memory IC die and memory IC dies 130a-130b and 130d-130e (and/or stacked die component 110) are configured in a recovery mode to propagate parity information to failing/failed memory IC die 130c. However, this is merely an example, and it should be understood that similar operations and data flows may be used in the event other of memory IC die 130a-130d are failing and/or have failed.

In FIG. 1E, controller 120 transmits a read command and address to stacked die component 110 via CA interface 125 and CA interface 145. The read command and address are provided by stacked die component 110 to the CA interfaces 135a-135e of memory IC dies 130a-130e (e.g., by TSVs, not shown in FIGS. 1A-1H). This is illustrated in FIG. 1E by the arrow originating with CA interface 125 of controller 120 and branches off that arrow running to CA interfaces 135a-135e.

In response to the read command, and based on stacked die component 110 being configured in a recovery mode, parity memory IC die 130e reads the corresponding complete parity information from memory array 136e and provides the complete parity information from memory array 136e to its B interface 133e. Availability circuitry 137d of memory IC die 130d receives the complete parity information via TSVs 142d and A interface 132d. This is illustrated in FIG. 1E by the arrows running from memory array 136e to parity circuitry 138d via B interface 133e, TSVs 142d, and A interface 132d.

In response to the read command, and based on stacked die component 110 being configured in the recovery mode, memory IC die 130d reads the corresponding data from memory array 136d and provides the data it read from memory array 136d to its DQ interface 131d (not shown in FIG. 1E) and to its availability circuitry 137d. Availability circuitry 137d calculates first partial parity information from the complete parity information received via A interface 132d and the data read from memory array 136d. The first partial parity information calculated by availability circuitry 137d (and parity circuitry 138d, in particular) is provided to B interface 133d. Availability circuitry 137c of failing/failed memory IC die 130c receives the first (upper) partial parity information via TSVs 142c and A interface 132c. This is illustrated in FIG. 1E by the arrows running from availability circuitry 137d to parity circuitry 138c via B interface 133d, TSVs 142c, and A interface 132c.

In response to the read command, and based on stacked die component 110 being configured in a recovery mode, memory IC die 130a reads the corresponding data from memory array 136a and provides the data from memory array 136a to its A interface 132a (and/or to its A interface 132a via availability circuitry 137a). Availability circuitry 137b of memory IC die 130b receives the data read from memory array 136a via TSVs 142a and B interface 133b. This is illustrated in FIG. 1E by the arrows running from memory array 136a to parity circuitry 138b via A interface 132a, TSVs 142a, and B interface 133b.

In response to the read command, and based on stacked die component 110 being configured in the recovery mode, memory IC die 130b reads the corresponding data from memory array 136b and provides the data it read from memory array 136b to its DQ interface 131b (not shown in FIG. 1E) and to its availability circuitry 137b. Availability circuitry 137b calculates second partial parity information from the data received via B interface 133b and the data read from memory array 136b. The second partial parity information calculated by availability circuitry 137b (and parity circuitry 138b, in particular) is provided to A interface 132b. Availability circuitry 137c of failing/failed memory IC die 130c receives the second partial parity information via B interface 133c. This is illustrated in FIG. 1E by the arrows running from availability circuitry 137b to parity circuitry 138c via A interface 132b, TSVs 142b, and B interface 133c.

In response to the read command, and based on stacked die component 110 being configured in the recovery mode, memory IC die 130c calculates a recovered data information from the first partial parity received from memory IC die 130d and the second partial parity information received from memory IC die 130b. Memory IC die 130c provides the recovered data information to its DQ interface 131c and controller 120. This is illustrated in FIG. 1E by the arrows running from availability circuitry 137c to DQ interface 121 of controller 120 via DQ interface 131c, TSVs 141b, and TSVs 141a.

In an embodiment stacked die component 110 may be placed in a recovery mode to recover data previously stored by a failing/failed memory IC die 130a-130d, store it in parity memory IC die 130e, and then respond to accesses using the parity memory IC die as a replacement for the failing/failed memory IC die 130a-130d. Based on being in a recovery mode (e.g., modes set by mode circuitry 134a-134e), the memory IC dies 130a-130e of stacked die component 110 and controller 120 collectively act to recover the data in the failing/failed device and store it in the parity memory IC die 130e. Under the control of controller 120, the non-failing/failed memory IC dies (e.g., memory IC dies 130a-130b and 130d-130e in FIG. 1E) in stacked die component 110 collectively calculate and provide partial parity data to the parity memory IC die 130e so that parity memory IC die 130e, using the complete parity data stored in its memory array 136e, can calculate the data previously stored by the failing/failed memory IC die and store it in memory array 136e thereby replacing the complete parity information in memory array 136e with the data previously stored by the failing/failed memory IC die.

In an embodiment, controller 120 manages the reconstruction of the failing/failed memory IC die by sending a series of commands and addresses to stacked die component 110, where each of the series of commands/addresses causes the reconstruction of granular portion (e.g., one address, one block of addresses, etc.) of the data previously stored by the failing/failed memory IC die. In another embodiment, controller 120 sends a single (or small number of) reconstruct command and the stacked die component 110 autonomously reconstructs all or a significant (e.g., ¼ of, ½ of, 1 bank of, etc.) portion of the data previously stored in 136c. In an embodiment, after the data in the failing/failed memory IC die has been reconstructed in parity memory IC die 130e, memory IC die 130e may respond to read commands with the reconstructed data rather than using data from the failing/failed memory IC die.

In an embodiment, to reconstruct the data in the failing/failed memory IC die, the non-failing/failed memory IC dies 130a-130e in stacked die component 110 collectively provide parity data to the next device above (a.k.a., adjacent) culminating with the parity memory IC die (e.g., memory IC die 130e) receiving partial parity information that was calculated from the data stored by each of the non-failing memory IC dies 130a-130d. This partial parity information is used along with the complete parity information retrieved by the parity memory IC die 130e from its own memory array 136e to reconstruct the data previously stored by the failing/failed memory IC die. The reconstructed data is then stored into the parity memory IC die 130e's memory array 136e so that the parity memory IC die 130e may respond to accesses in place of the failing/failed memory IC dies 130a-130d of stacked die component 110.

In particular, each non-failing memory IC die 130a-130d calculates a partial parity based on the parity information received from the memory IC die 130a-130d below it, and corresponding (e.g., same address) data retrieved from its memory array. Each non-failing memory IC die 130a-130d transmits the partial parity information it calculated to the memory IC die above it. The failing/failed memory IC die 130a-130d merely relays the partial parity information it receives to the memory IC die above it. At the top of stacked die component 110, the parity memory IC die 130e receives the partial parity calculated from the data in all of the non-failing memory IC dies 130a-130d. The partial parity information received by the parity memory IC die 130e and the corresponding (e.g., same address) complete parity information obtained from memory array 136e is exclusive-OR'd to reconstruct the data previously stored by the failing/failed memory IC die 130a-130d. The reconstructed data is then stored into the parity memory IC die 130e's memory array 136e so that the parity memory IC die 130e may respond to accesses in place of the failing/failed memory IC dies 130a-130d of stacked die component 110.

These operations and dataflows are illustrated by example in FIG. 1F. In FIG. 1F, memory IC die 130c is configured as the failing/failed memory IC die and memory IC dies 130a-130b and 130d-130e (and/or stacked die component 110) are configured in a reconstruction mode to propagate parity information to parity memory IC die 130e. However, this is merely an example, and it should be understood that similar operations and data flows may be used in the event other of memory IC die 130a-130d are failing and/or have failed. FIG. 1F illustrates a first example reconstruction mode operation performed in response to a reconstruct command transmitted to stacked die component 110.

In FIG. 1F, controller 120 transmits a reconstruct command and address to stacked die component 110 via CA interface 125 and CA interface 145. The reconstruct command and address are provided by stacked die component 110 to the CA interfaces 135a-135e of memory IC dies 130a-130e (e.g., by TSVs, not shown in FIGS. 1A-1H). This is illustrated in FIG. 1F by the arrow originating with CA interface 125 of controller 120 and branches off that arrow running to CA interfaces 135a-135e.

In FIG. 1F, memory IC die 130a (e.g., by availability circuitry 137a, in particular) provides the read data it received from its memory array 136a in response to the reconstruct command to memory IC die 130b via A interface 132a, TSVs 142a, and B interface 133b of memory IC die 130b. This is illustrated in FIG. 1F by the arrow running from memory array 136a to parity circuitry 138b of memory IC die 130b via A interface 132a, TSVs 142a, and B interface 133b.

Memory IC die 130b calculates a first partial parity from the data it received from memory IC die 130a and read data it received from its memory array 136b. Memory IC die 130b provides the first partial parity to memory IC die 130c via A interface 132b, TSVs 142b, and B interface 133c of memory IC die 130c. This is illustrated in FIG. 1F by the arrow running from memory array 136b to availability circuitry 137b (and parity circuitry 138b, in particular) and the arrow from parity circuitry 138b to availability circuitry 137c of memory IC die 130c via A interface 132b, TSVs 142b, and B interface 133c.

Memory IC die 130c provides the first partial parity it received via B interface 133c to memory IC die 130d via A interface 132c, TSVs 142c, and B interface 133d of memory IC die 130d. This is illustrated in FIG. 1F by the arrow running from availability circuitry 137c to parity circuitry 138d of memory IC die 130d via A interface 132c, TSVs 142c, and B interface 133d.

Memory IC die 130d calculates a second parity from the first partial parity data it received from memory IC die 130c and read data it received from its memory array 136d. Memory IC die 130d provides the second partial parity to memory IC die 130e via A interface 132d, TSVs 142d, and B interface 133e of memory IC die 130e. This is illustrated in FIG. 1F by the arrow running from availability circuitry 137d (and parity circuitry 138d, in particular) to parity circuitry 138e of memory IC die 130e via A interface 132d, TSVs 142d, and B interface 133e.

Memory IC die 130e reconstructs (i.e., calculates) the data previously stored by failing/failed memory IC die 130c from the second partial parity data it received from memory IC die 130d and read data it received from its memory array 136e. This is illustrated in FIG. 1F by the arrow running from memory array 136e to availability circuitry 137e (and parity circuitry 138e, in particular) and the arrow running from availability circuitry 137d to availability circuitry 137e of memory IC die 130e via A interface 132d, TSVs 142d, and B interface 133e.

Memory IC die 130e stores the reconstructed data into a corresponding location in memory array 136e. This is illustrated in FIG. 1F by the arrow running from availability circuitry 137e (and parity circuitry 138e, in particular), to memory array 136e.

From the foregoing, it should be understood that for the respective data output by each non-failing memory IC die 130a-130d on A interface 132a-132d may be expressed as Dₐ[ ]=Dₘ[ ] ⊗D_{b}[ ] where D_{b}[ ] for memory IC die 130a (e.g., the “bottom” device) and Dₘ[ ] for memory IC die 130c (e.g., the “failing” device) are equivalent to all logical “0”'s. In other words, for example, where Dₐ[ ], D_{b}[ ], Dₓ[ ], and Dₘ[ ] are each 32 bits wide, each non-failing memory IC die 130a-130d calculates, receives, and propagates parity/partial parity according to the formula: Dₐ[0:31]=Dₘ[0:31] @D_{b}[0:31] where D_{b}[0:31] for memory IC die 130a and Dₘ[0:31] for memory IC die 130c are set or configured to be 0000hex (or equivalent). Thus, it should also be understood that parity memory IC die 130e receives is a partial parity value, as collectively calculated by memory devices 130a-130d according to:

$${D}_{b , 130 e} [ 0 : 31 ] = {D}_{m , 130 a} [ 0 : 31 ] ⊗ {D}_{m , 130 b} [ 0 : 31 ] ⊗ {D}_{m , 130 d} [ 0 : 31 ]$$

And the value stored by the parity memory IC die 130e is according to:

$${D}_{m , 130 e , write} [ 0 : 31 ] = {D}_{b , 130 e} [ 0 : 31 ] ⊗ {D}_{m , 130 e , read} [ 0 : 31 ]$$

(or equivalent) based on the reconstruct command transmitted to stacked die component 110.

FIG. 1G illustrates a first example recovery mode operation performed for a write to stacked die component 110. In FIG. 1G, controller 120 transmits a write command and address to stacked die component 110 via CA interface 125 and CA interface 145. The write command and address are provided by stacked die component 110 to the CA interfaces 135a-135e of memory IC dies 130a-130e (e.g., by TSVs, not shown in FIGS. 1A-1H). This is illustrated in FIG. 1G by the arrow originating with CA interface 125 of controller 120 and branches off that arrow running to CA interfaces 135a-135e.

As part of the write operation, controller 120 transmits write data to stacked die component 110 via DQ interface 121 and DQ interface 143. Corresponding portions (e.g., two bits) of the write is provided by stacked die component 110 to respective DQ interfaces 131a-131b and 131d-131e of memory IC dies 130a-130b and 130d-130e (e.g., by one or more of TSVs 141a-141d). This is illustrated in FIG. 1G by the arrow originating with DQ interface 121 of controller 120 and branches off that arrow running to DQ interfaces 131a-131b and 131d-131e via one or more of TSVs 141a-141d. DQ interfaces 131a-131b and 131d-131e provide their respectively received write data to their availability circuitry 137a-137b and 137d-137e and their memory array 136a-136b and 136d-136e. Respectively received write data is stored (i.e., written) to the respective memory array 136a-136b and 136d-136e (e.g., under the control of control circuitry 139a-139b and 139d-139e). Note that in this example, failing memory IC die 130c does not write data received from controller 120 to memory array 136c (e.g., either because it was configured not to, and/or DQ interface 131c was disabled—e.g., by control circuitry 139c). However, in some embodiments, memory IC die 130c may write data received from controller 120 to memory array 136c. In these embodiments, controller 120 may be configured to ignore data read from memory array 136c and transmitted via DQ interface 131c and instead use data read from memory array 136e in its place.

FIG. 1H illustrates a first example recovery mode operation performed for a read from stacked die component 110. In FIG. 1H, controller 120 transmits a read command and address to stacked die component 110 via CA interface 125 and CA interface 145. The read command and address are provided by stacked die component 110 to the CA interfaces 135a-135e of memory IC dies 130a-130e (e.g., by TSVs, not shown in FIGS. 1A-1H). This is illustrated in FIG. 1H by the arrow originating with CA interface 125 of controller 120 and branches off that arrow running to CA interfaces 135a-135e.

As part of the read operation, each data memory IC die 130a-130b and 130d-130e transmits read data to controller 120 via one or more TSVs 141a-141d, DQ interface 143, and DQ interface 121. Corresponding portions (e.g., two bits) of the read data are provided by each data memory IC die 130a-130b and 130d-130e by respective DQ interfaces 131a-131b and 131d-131e to controller 120. This is illustrated in FIG. 1H by the arrows originating with memory arrays 136a-136b and 136d-136e that joining with the other arrows and run to DQ interface 121 via one or more of TSVs 141a-141d. Note that in this example, failing memory IC die 130c does not provide data read from memory array 136c to controller 120 (e.g., either because it was configured not to, and/or DQ interface 131c was disabled—e.g., by control circuitry 139c). However, in some embodiments, memory IC die 130c may provide data read from memory array 136c to controller 120. In these embodiments, controller 120 may be configured to ignore data read from memory array 136c and transmitted via DQ interface 131c and instead use data read from memory array 136e in its place.

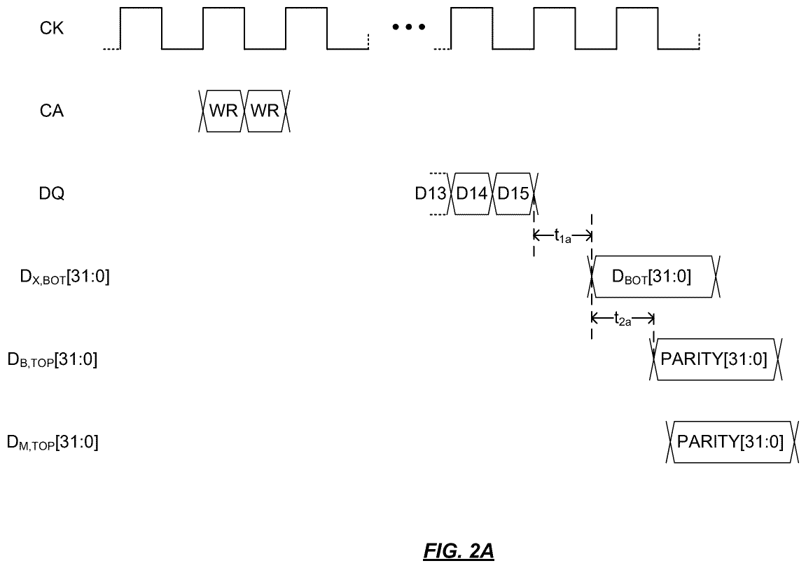

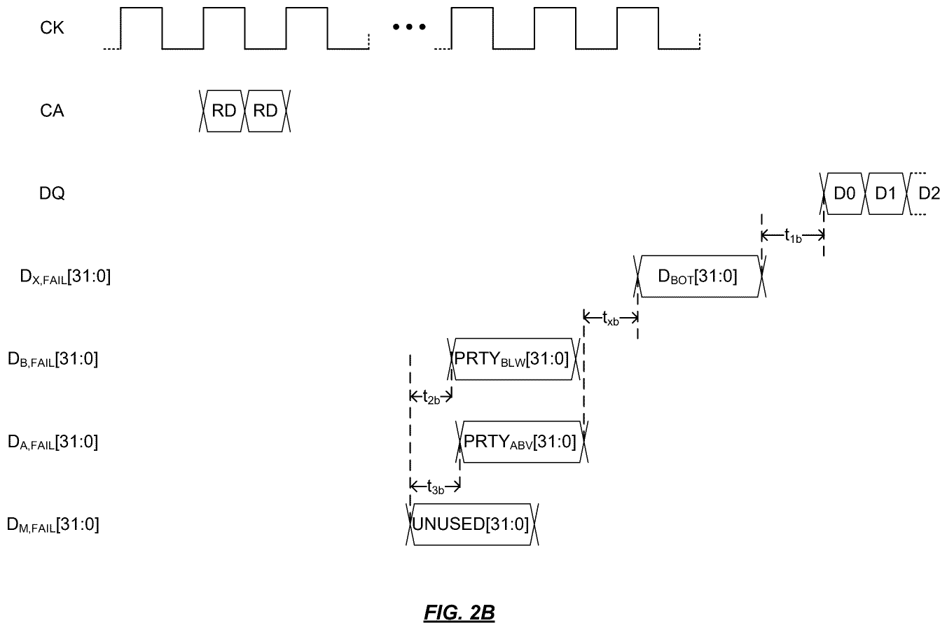

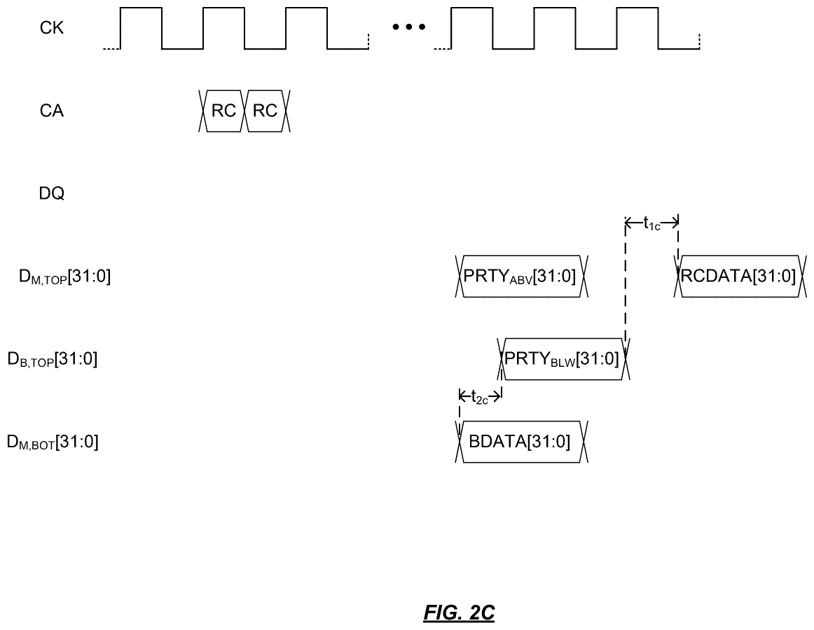

FIG. 2A illustrates an example timing diagram for a write operation to a memory device stack. One or more of the timings, signals, operations, and/or functions illustrated in FIG. 2A may be used by one or more elements of, for example, memory system 100 and/or its components. In FIG. 2A, the diagram begins with a write command that is transmitted via a command/address (CA) bus to a memory device stack. This is illustrated in FIG. 2A by the “WR” signals over two unit intervals on the CA bus. After a write latency period (not shown in FIG. 2A) and the data (DQ) transmission period (not shown in FIG. 2A), the transmission of data corresponding to the write command completes. This is illustrated in FIG. 2A by the end of the “D15” signals on the DQ bus ending.

After a deserialization delay corresponding to the amount of time for the bottom memory IC die (e.g., memory IC die 130a) to deserialize the write data it received (e.g., from 2 bits received over 16 unit intervals to 32 parallel bits) the write data is provided to the availability circuitry (and parity calculation circuitry, in particular). This is illustrated in FIG. 2A by the time interval t₁ₐ from the end of the “D15” signals to the start of D_{BOT}[31:0] on the D_{x, BOT}[31:0] bus of the bottom device's Dₓ[ ] bus.

After a propagation delay corresponding to the amount of time for the partial parity information calculated by the data memory IC dies (e.g., memory IC die 130a-130d) to be calculated, received, and transmitted by data memory IC die, complete parity information is provided to the “B” (bottom) interface of the parity memory IC die. This is illustrated in FIG. 2A by the time interval t₂ₐ from the end of the t₁ₐ delay/interval to the start of PARITY[31:0] signals on the D_{B, TOP}[31:0] bus of the parity memory IC die. The complete parity information is written the memory array of the parity memory IC die. This is illustrated in FIG. 2A the PARITY[31:0] signals on the D_{m, TOP}[31:0] bus of the parity memory IC die.

FIG. 2B illustrates an example timing diagram for a read operation from a memory device stack having a failing memory IC die. One or more of the timings, signals, operations, and/or functions illustrated in FIG. 2B may be used by one or more elements of, for example, memory system 100 and/or its components. In FIG. 2B, the diagram begins with a read command that is transmitted via a command/address (CA) bus to a memory device stack. This is illustrated in FIG. 2B by the “RD” signals over two unit intervals on the CA bus. After a read latency period (not shown in FIG. 2B), the memory array of the failing device may optionally provide data from its memory array to availability logic. This is illustrated in FIG. 2B by the UNUSED[31:0] on the D_{M}[ ] bus (i.e., D_{M,FAIL}[31:0]) of the failing memory IC die.

After a propagation delay corresponding to the amount of time for the partial parity information calculated by the data memory IC dies (e.g., memory IC die 130a-130b) below the failing memory IC die to be calculated, received, and transmitted, partial parity information is provided to the “B” (bottom) interface of the failing memory IC die. This is illustrated in FIG. 2B by the time interval t_{2b} from the start of the UNUSED[31:0] signals to the start of partial parity PRTY_{BLW}[31:0] signals on the D_{B}[ ] bus (i.e., D_{B, FAIL}[31:0]) of the failing memory IC die. After a propagation delay corresponding to the amount of time for the partial parity information calculated by the data memory IC dies (e.g., memory IC die 130d-130e) above the failing memory IC die to be calculated, received, and transmitted, partial parity information is provided to the “A” (above) interface of the failing memory IC die. This is illustrated in FIG. 2B by the time interval t_{3b} from the start of the UNUSED[31:0] signals to the start of partial parity PRTY_{ABV}[31:0] signals on the Dₐ[ ] bus (i.e., D_{A, FAIL}[31:0]) of the failing memory IC die.

After an XOR calculation delay, the reconstructed data previously provided by the memory array of the failing memory IC die is provided to the DQ interface circuits of the failing memory IC die. This is illustrated in FIG. 2B by the time interval t_{xb} from the end of the later of the partial parity PRTY_{ABV}[31:0] signals and the partial parity PRTY_{BLW}[31:0] signals to the start of D_{BOT}[31:0] on the Dₓ[ ] bus (i.e., D_{x, FAIL} [31:0]) of the failing device.

After a serialization delay corresponding to the amount of time for the failing memory IC die (e.g., memory IC die 130c) to serialize the first part (e.g., 2 bits) of the reconstructed read data (e.g., from 32 bits in parallel to the first two serialized bits), serialized version of the reconstructed data is transmitted via the DQ bus of the failing memory device. This is illustrated in FIG. 2B by the time interval tib from the end of the D_{BOT}[31:0] signals to the start of “D0” on the DQ bus of the failing device.

FIG. 2C illustrates an example timing diagram for a recovery operation for a memory device stack having a failing memory IC die. One or more of the timings, signals, operations, and/or functions illustrated in FIG. 2C may be used by one or more elements of, for example, memory system 100 and/or its components. In FIG. 2C, the diagram begins with a recover command that is transmitted via a command/address (CA) bus to a memory device stack. This is illustrated in FIG. 2C by the “RC” signals over two unit intervals on the CA bus. After a read latency period (not shown in FIG. 2C), the memory array of the bottom device provides data from its memory array to availability logic. This is illustrated in FIG. 2C by the BDATA[31:0] on the D_{M}[ ] bus (i.e., D_{M,BOT}[31:0]) of the bottom memory IC die. After a read latency period (not shown in FIG. 2C), the memory array of the parity device provides complete parity data from its memory array to availability logic. This is illustrated in FIG. 2C by the PRTY[31:0] on the D_{M}[ ] bus (i.e., D_{M,TOP}[31:0]) of the parity memory IC die.

After a propagation delay corresponding to the amount of time for the partial parity information calculated by the non-failing data memory IC dies (e.g., memory IC die 130a-103b and 130d) below the parity memory IC die to be calculated, received, and transmitted, partial parity information is provided to the “B” interface of the parity memory IC die. This is illustrated in FIG. 2C by the time interval the from the start of the BDATA[31:0] signals to the start of partial parity PRTY_{BLW}[31:0] signals on the D_{B}[ ] bus (i.e., D_{B, TOP}[31:0]) of the parity memory IC die.

After an XOR calculation delay, the recovered data previously provided by the memory array of the failing memory IC die is provided to the memory array of the parity memory IC die. This is illustrated in FIG. 2C by the time interval t_{1c} from the later of the partial parity PRTY_{ABV}[31:0] signals and the partial parity PRTY_{BLW}[31:0] signals to the start of RCDATA[31:0] on the D_{M}[ ] bus (i.e., D_{M, TOP}[31:0]) of the parity memory IC die.

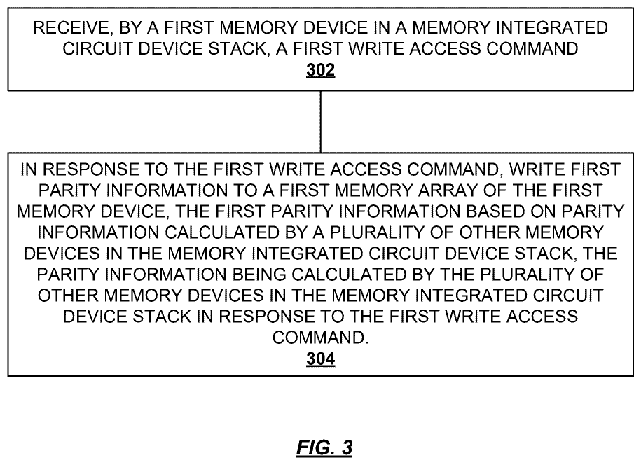

FIG. 3 is a flowchart illustrating a method of operating a memory device stack. One or more of the steps illustrated in FIG. 3 may be performed by, for example, memory system 100, and/or its components. By a first memory device in a memory integrated circuit device stack, a first write access command is received (302). For example, memory IC dies 130a-130e of stacked die component 110 may receive a write access command from controller 120 where memory IC die 130e is configured to store parity information in response to write access commands.

In response to the first write access command, first parity information is written to a first memory array of the first memory device where the first parity information is based on parity information calculated by a plurality of other memory devices in the memory integrated circuit device stack and the parity information was calculated by the plurality of other memory devices in the memory integrated circuit device stack in response to the first write access command (304). For example, parity memory IC die 130e may write to memory array 136e parity information calculated by data memory IC dies 130a-130d where that parity information was calculated by data memory IC dies 130a-130d based on data received by data memory IC dies 130a-130d as part of same write access command and in response to that same write access command.

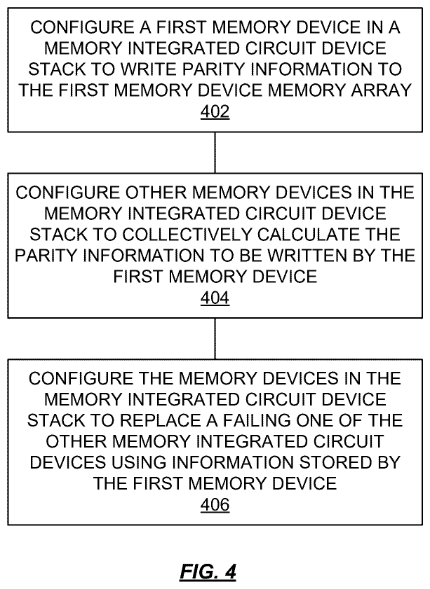

FIG. 4 is a flowchart illustrating a method of operating a memory device stack having a failed device. One or more of the steps illustrated in FIG. 4 may be performed by, for example, memory system 100, and/or its components. A first memory device in a memory integrated circuit device stack is configured to write parity information to the first memory device memory array (402). For example, parity memory IC die 130e may be configured to write parity information associated with write commands received by stacked die component 110 to memory array 136e.

The other memory devices in the memory integrated circuit device stack are configured to collectively calculate the parity information to be written by the first memory device (404). For example, memory IC dies 130a-130d may be configured to collectively calculate parity information over the write data collectively received by memory IC dies 130a-130d. Memory IC dies 130a-130d may collectively calculate the parity information by performing a distributed, over memory IC dies 130a-130d, exclusive-OR function of the data received by memory IC dies 130a-130d as part of a write command to stacked die component 110.

The memory device in the memory integrated circuit device stack are configured to replace a failing one of the other memory integrated circuit devices using information stored by the first memory device (406). For example, a failing memory device (e.g., memory IC die 130c) may reconstruct data previously stored by the failing memory device using parity information received from, and/or processed by, the non-failing memory devices (e.g., memory IC dies 130a-130b and 130d-130e).

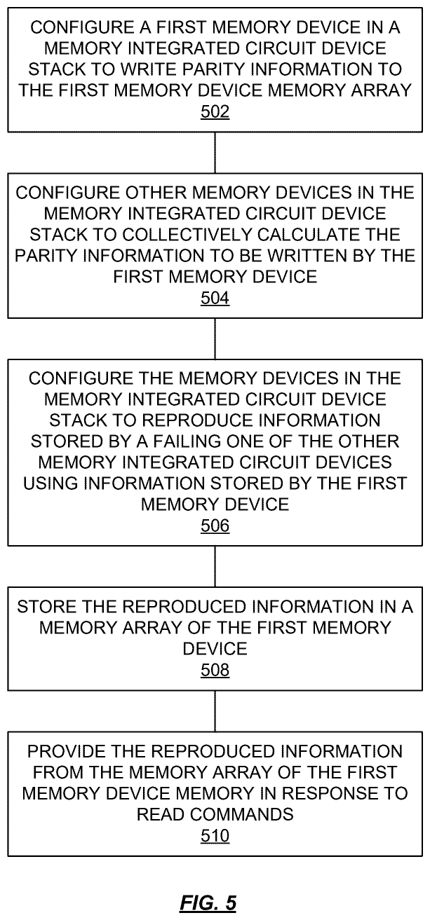

FIG. 5 is a flowchart illustrating a method of recovering information stored in a memory device stack having a failed device. One or more of the steps illustrated in FIG. 5 may be performed by, for example, memory system 100, and/or its components. A first memory device in a memory integrated circuit device stack is configured to write parity information to the first memory device memory array (502). For example, parity memory IC die 130e may be configured to write parity information associated with write commands received by stacked die component 110 to memory array 136e.

The other memory devices in the memory integrated circuit device stack are configured to collectively calculate the parity information to be written by the first memory device (504). For example, memory IC dies 130a-130d may be configured to collectively calculate parity information over the write data collectively received by memory IC dies 130a-130d. Memory IC dies 130a-130d may collectively calculate the parity information by performing a distributed, over memory IC dies 130a-130d, exclusive-OR function of the data received by memory IC dies 130a-130d as part of a write command to stacked die component 110.

The memory devices of the memory integrated circuit device stack are configured to reproduce information previously stored by a failing one of the other memory integrated circuit devices using information stored by the first memory device (506). For example, parity information stored by parity memory device (e.g., memory IC die 130e) may be used to recover data previously stored by the failing memory device using parity information received from, and/or processed by, the other non-failing memory devices (e.g., memory IC dies 130a-130b and 130d).

The reproduced information is stored in a memory array of the first memory device (508). For example, the recovered information previously stored by a failing one of the other memory integrated circuit devices may be stored back to a memory array (e.g., memory array 136e) of the parity memory device (e.g., memory IC die 130e). The reproduced information from the memory array of the first memory device is provided in response to read commands (510). For example, the parity memory may provide, in response to read commands, data stored in its memory array to a controller to allow the parity memory device to act as a replacement for the failing memory device (e.g., by transmitting, to the controller, the recovered data and/or data newly stored to the parity memory device that would have been stored by the failing memory device before it was failing).

The methods, systems and devices described above may be implemented in computer systems, or stored by computer systems. The methods described above may also be stored on a non-transitory computer readable medium. Devices, circuits, and systems described herein may be implemented using computer-aided design tools available in the art, and embodied by computer-readable files containing software descriptions of such circuits. This includes, but is not limited to one or more elements of memory system 100, its components. These software descriptions may be: behavioral, register transfer, logic component, transistor, and layout geometry-level descriptions. Moreover, the software descriptions may be stored on storage media or communicated by carrier waves.

Data formats in which such descriptions may be implemented include, but are not limited to: formats supporting behavioral languages like C, formats supporting register transfer level (RTL) languages like Verilog and VHDL, formats supporting geometry description languages (such as GDSII, GDSIII, GDSIV, CIF, and MEBES), and other suitable formats and languages. Moreover, data transfers of such files on machine-readable media may be done electronically over the diverse media on the Internet or, for example, via email. Note that physical files may be implemented on machine-readable media such as: 4 mm magnetic tape, 8 mm magnetic tape, 3½ inch floppy media, CDs, DVDs, and so on.

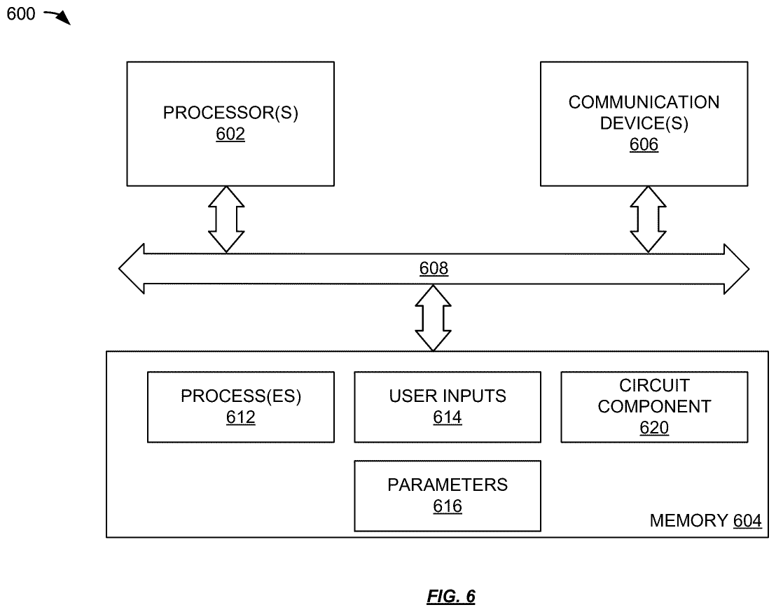

FIG. 6 is a block diagram illustrating one embodiment of a processing system 600 for including, processing, or generating, a representation of a circuit component 620. Processing system 600 includes one or more processors 602, a memory 604, and one or more communications devices 606. Processors 602, memory 604, and communications devices 606 communicate using any suitable type, number, and/or configuration of wired and/or wireless connections 608.

Processors 602 execute instructions of one or more processes 612 stored in a memory 604 to process and/or generate circuit component 620 responsive to user inputs 614 and parameters 616. Processes 612 may be any suitable electronic design automation (EDA) tool or portion thereof used to design, simulate, analyze, and/or verify electronic circuitry and/or generate photomasks for electronic circuitry. Representation 620 includes data that describes all or portions of memory system 100, its components, as shown in the Figures.

Representation 620 may include one or more of behavioral, register transfer, logic component, transistor, and layout geometry-level descriptions. Moreover, representation 620 may be stored on storage media or communicated by carrier waves.

Data formats in which representation 620 may be implemented include, but are not limited to: formats supporting behavioral languages like C, formats supporting register transfer level (RTL) languages like Verilog and VHDL, formats supporting geometry description languages (such as GDSII, GDSIII, GDSIV, CIF, and MEBES), and other suitable formats and languages. Moreover, data transfers of such files on machine-readable media may be done electronically over the diverse media on the Internet or, for example, via email

User inputs 614 may comprise input parameters from a keyboard, mouse, voice recognition interface, microphone and speakers, graphical display, touch screen, or other type of user interface device. This user interface may be distributed among multiple interface devices. Parameters 616 may include specifications and/or characteristics that are input to help define representation 620. For example, parameters 616 may include information that defines device types (e.g., NFET, PFET, etc.), topology (e.g., block diagrams, circuit descriptions, schematics, etc.), and/or device descriptions (e.g., device properties, device dimensions, power supply voltages, simulation temperatures, simulation models, etc.).

Memory 604 includes any suitable type, number, and/or configuration of non-transitory computer-readable storage media that stores processes 612, user inputs 614, parameters 616, and circuit component 620.

Communications devices 606 include any suitable type, number, and/or configuration of wired and/or wireless devices that transmit information from processing system 600 to another processing or storage system (not shown) and/or receive information from another processing or storage system (not shown). For example, communications devices 606 may transmit circuit component 620 to another system. Communications devices 606 may receive processes 612, user inputs 614, parameters 616, and/or circuit component 620 and cause processes 612, user inputs 614, parameters 616, and/or circuit component 620 to be stored in memory 604.

Implementations discussed herein include, but are not limited to, the following examples:

Example 1: An integrated circuit stack, comprising: a first memory device comprising at least a first memory array and first through-silicon vias (TSVs); a second memory device comprising at least a second memory array, second TSVs, and parity calculation circuitry to calculate first parity information based on first information received from the first TSVs and second information to be stored in the second memory array, the second memory device to transmit the first parity information via the second TSVs; and a third memory device comprising at least a third memory array, the third memory device to receive the first parity information from the second TSVs and to store the first parity information in the third memory array.

Example 2: The integrated circuit stack of example 1, wherein the first information is second parity information based on third information to be stored in a fourth memory array of a fourth memory device in the integrated circuit stack.

Example 3: The integrated circuit stack of example 1, wherein the second memory device is to calculate calculated first information based on the first parity information received from the third memory device and the first information received from the first memory device.

Example 4: The integrated circuit stack of example 3, wherein the second memory device is to transmit, to a device external to the integrated circuit stack, the calculated first information.

Example 5: The integrated circuit stack of example 1, wherein the third memory device is to calculate calculated second information based on the first parity information retrieved from the third memory array and the first information received via the second memory device.

Example 6: The integrated circuit stack of example 5, wherein the third memory device is to store the second information in the third memory array.

Example 7: The integrated circuit stack of example 6, wherein the third memory device is to transmit the second information retrieved from the third memory array to a device external to the integrated circuit stack.

Example 8: An assembly, comprising: an external command/address (CA) interface to receive commands and addresses from a device external to the assembly; a first memory integrated circuit coupled to the external CA interface and comprising a first memory array, a first data interface, a first parity interface, and first parity calculation circuitry; a second memory integrated circuit coupled to the external CA interface and being stacked with the first memory integrated circuit and being electrically coupled to the first parity interface, the second memory integrated circuit comprising a second memory array, a second data interface, a second parity interface, and second parity calculation circuitry, the first parity calculation circuitry to calculate first parity information based on first information received via the first parity interface and second information received via the first data interface; and a third memory integrated circuit coupled to the external CA interface and comprising a third memory array and a third parity interface to receive the first parity information, the third memory integrated circuit to store, in the third memory array, the first parity information.

Example 9: The assembly of example 8, wherein the second memory integrated circuit is to base the first information on third information received via the second data interface.

Example 10: The assembly of example 9, wherein the second memory integrated circuit is to transmit the first information to the first parity interface.

Example 11: The assembly of example 8, wherein the third memory integrated circuit is to transmit, via the third parity interface and to the first memory integrated circuit, second parity information retrieved from the third memory array.

Example 12: The assembly of example 11, wherein the first memory integrated circuit is to transmit, via the first parity interface and to the second memory integrated circuit, second parity information, the second parity information based on first data information retrieved from the first memory array and the second parity information.

Example 13: The assembly of example 12, wherein the second memory integrated circuit is to transmit, via the second data interface and to the device external to the assembly, second data information, the second data information based on third parity information received via the second below parity interface and the second parity information transmitted by the third memory integrated circuit.

Example 14: The assembly of example 8, wherein the third memory integrated circuit is to recalculate the second information based on the first parity information retrieved from the third memory array and third parity information received from the first memory integrated circuit.

Example 15: The assembly of example 14, wherein the third memory integrated circuit is to store the second information in the third memory array.

Example 16: A method, comprising: receiving, by a first memory device in a memory integrated circuit device stack, a first write access command; and in response to the first write access command, writing first parity information to a first memory array of the first memory device, the first parity information based on parity information calculated by a plurality of other memory devices in the memory integrated circuit device stack, the parity information being calculated by the plurality of other memory devices in the memory integrated circuit device stack in response to the first write access command.

Example 17: The method of example 16, further comprising: configuring the first memory device to write the first parity information to the first memory array.

Example 18: The method of example 17, further comprising: configuring the plurality of other memory devices to collectively calculate the first parity information.

Example 19: The method of example 16, further comprising: configuring the memory integrated circuit device stack to replace a failing one of the plurality of other memory devices using information stored by the first memory device.

Example 20: The method of example 16, further comprising: configuring the memory integrated circuit device stack to reproduce information stored by a failing one of the plurality of other memory devices; and storing the reproduced information in the first memory device.

The foregoing description of the invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. An integrated circuit stack, comprising:
a first memory device comprising at least a first memory array and first through-silicon vias (TSVs);
a second memory device comprising at least a second memory array, second TSVs, and parity calculation circuitry to calculate first parity information based on first information received from the first TSVs and second information to be stored in the second memory array, the second memory device to transmit the first parity information via the second TSVs; and
a third memory device comprising at least a third memory array, the third memory device to receive the first parity information from the second TSVs and to store the first parity information in the third memory array.

2. The integrated circuit stack of claim 1, wherein the first information is second parity information based on third information to be stored in a fourth memory array of a fourth memory device in the integrated circuit stack.

3. The integrated circuit stack of claim 1, wherein the second memory device is to calculate calculated first information based on the first parity information received from the third memory device and the first information received from the first memory device.

4. The integrated circuit stack of claim 3, wherein the second memory device is to transmit, to a device external to the integrated circuit stack, the calculated first information.

5. The integrated circuit stack of claim 1, wherein the third memory device is to calculate calculated second information based on the first parity information retrieved from the third memory array and the first information received via the second memory device.

6. The integrated circuit stack of claim 5, wherein the third memory device is to store the second information in the third memory array.

7. The integrated circuit stack of claim 6, wherein the third memory device is to transmit the second information retrieved from the third memory array to a device external to the integrated circuit stack.

8. An assembly, comprising:
an external command/address (CA) interface to receive commands and addresses from a device external to the assembly;
a first memory integrated circuit coupled to the external CA interface and comprising a first memory array, a first data interface, a first above parity interface, a first below parity interface, and first parity calculation circuitry;
a second memory integrated circuit coupled to the external CA interface and being stacked with the first memory integrated circuit, the second memory integrated circuit comprising a second memory array, a second data interface, a second above parity interface, a second below parity interface, and second parity calculation circuitry, the second below parity interface being electrically coupled to the first above parity interface, the second parity calculation circuitry to calculate first parity information based on first information received via the second below parity interface and second information received via the second data interface; and
a third memory integrated circuit coupled to the external CA interface and comprising a third memory array and a third below parity interface to receive the first parity information, the third memory integrated circuit to store, in the third memory array, the first parity information.

9. The assembly of claim 8, wherein the first memory integrated circuit is to base the first information on third information received via the first data interface.

10. The assembly of claim 9, wherein the first memory integrated circuit is to transmit the first information to the second below parity interface.

11. The assembly of claim 8, wherein the third memory integrated circuit is to transmit, via the third below parity interface and to the second memory integrated circuit, second parity information retrieved from the third memory array.

12. The assembly of claim 11, wherein the first memory integrated circuit is to transmit, via the first above parity interface and to the second memory integrated circuit, third parity information, the third parity information based on first data information retrieved from the first memory array and fourth parity information received via the first below parity interface.

13. The assembly of claim 12, wherein the second memory integrated circuit is to transmit, via the second data interface and to the device external to the assembly, second data information, the second data information based on third parity information received via the second below parity interface and the second parity information transmitted by the third memory integrated circuit.

14. The assembly of claim 8, wherein the third memory integrated circuit is to recalculate the second information based on the first parity information retrieved from the third memory array and third parity information received from the second memory integrated circuit.

15. The assembly of claim 14, wherein the third memory integrated circuit is to store the second information in the third memory array.

16. A method, comprising:
receiving, by a first memory device in a memory integrated circuit device stack, a first write access command; and
in response to the first write access command, writing first parity information to a first memory array of the first memory device, the first parity information based on parity information calculated by a plurality of other memory devices in the memory integrated circuit device stack, the first parity information being calculated by the plurality of other memory devices in the memory integrated circuit device stack in response to the first write access command.

17. The method of claim 16, further comprising:
configuring the first memory device to write the first parity information to the first memory array.

18. The method of claim 17, further comprising:
configuring the plurality of other memory devices to collectively calculate the first parity information.

19. The method of claim 16, further comprising:
configuring the memory integrated circuit device stack to replace a failing one of the plurality of other memory devices using information stored by the first memory device.

20. The method of claim 16, further comprising:
configuring the memory integrated circuit device stack to reproduce information stored by a failing one of the plurality of other memory devices; and
storing the reproduced information in the first memory device.
